(19) United States
(12) Patent Application Publication
(10) Pub. No.: US 2008/0238114 A1
(43) Pub. Date: Oct. 2, 2008

(54) MODULAR CHASSIS LOCK BAR

(75) Inventor: Jeffrey R. McClellan, Raleigh, NC (US)

Correspondence Address: FOGG & POWERS LLC, 10 SOUTH FIFTH STREET, SUITE 1000, MINNEAPOLIS, MN, 55402, US

(73) Assignee: ADC DSL SYSTEMS, INC., Eden Prairie, MN (US)

(21) Appl. No.: 11/692,385

(22) Filed: Mar. 28, 2007

(51) Int. Cl. E05C 3/12

(52) U.S. Cl. 292/358

(57) ABSTRACT

A lock bar comprises two end sections, each end section including a slot configured to enable attaching the lock bar to a modular chassis and to enable moving the lock bar between a locked position and an unlocked position when the lock bar is attached to the modular chassis; and a middle section coupled to the two end sections and configured with a length longer than the width of the modular chassis.

### BACKGROUND

Many network systems use modular line cards to perform various functions. For example, in a Digital Subscriber Line (DSL) network, a chassis holds a plurality of line cards, where each line card functions as a terminal connecting subscriber premise DSL modems to the network. These line cards are typically secured inside the chassis with latches. The latches must be pulled or otherwise opened in order to remove a line card. Among other things, this helps maintain sufficient pressure to keep the line card connected to a motherboard in the chassis.

However, despite the use of latches, the line cards can become accidentally loosened or removed. For example, an operator or engineer walking past a chassis may bump into the latches or get an article of clothing caught on one of the latches. Similarly, vibration during transport of the chassis may cause the line cards to become loose. The movement of the operator can then pull open the latch and disconnect the line card. Even if the operator immediately notices what has happened, there is still a temporary loss of connection for subscribers connected to the line card that was disconnected.

### SUMMARY

In one embodiment, a lock bar is provided. The lock bar comprises two end sections, each end section including a slot configured to enable attaching the lock bar to a modular chassis and to enable moving the lock bar between a locked position and an unlocked position when the lock bar is attached to the modular chassis; and a middle section coupled to the two end sections and configured with a length longer than the width of the modular chassis.

### DRAWINGS

FIGS. 1A-1C depict a modular chassis system according to one embodiment of the present invention.

FIG. 2A depicts a top view of a lock bar according to one embodiment of the present invention.

FIG. 2B depicts a side view of a lock bar according to one embodiment of the present invention.

FIG. 2C depicts another side view of a lock bar according to one embodiment of the present invention.

FIGS. 3A-3B depicts a front view and a top view of a lock bar according to another embodiment of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical and mechanical changes may be made without departing from the scope of the present invention. The following detailed description is, therefore, not to be taken in a limiting sense.

Embodiments of the present invention reduce the likelihood of accidental disconnection or removal of line cards from a chassis. In particular, embodiments of the present invention use a lock bar to secure the latches and prevent the latches from being pulled open. In addition, embodiments of the present invention make it easy to use the lock bar by not having to detach the lock bar from the chassis when removing or inserting a line card into the chassis.

As used herein the term “modular chassis” (also referred to herein as a “chassis”, “shelf” or “mechanics shelf”) refers to a physical unit which is configured to receive one or more modular line cards. A chassis can also contain a motherboard, power supply, memory, and other circuitry which supports the function of line cards inserted into the chassis. In addition, the term “modular line card” (also referred to herein as simply “line card”) refers to an electronic circuit on a printed circuit board which can be separately removed and inserted into a chassis.

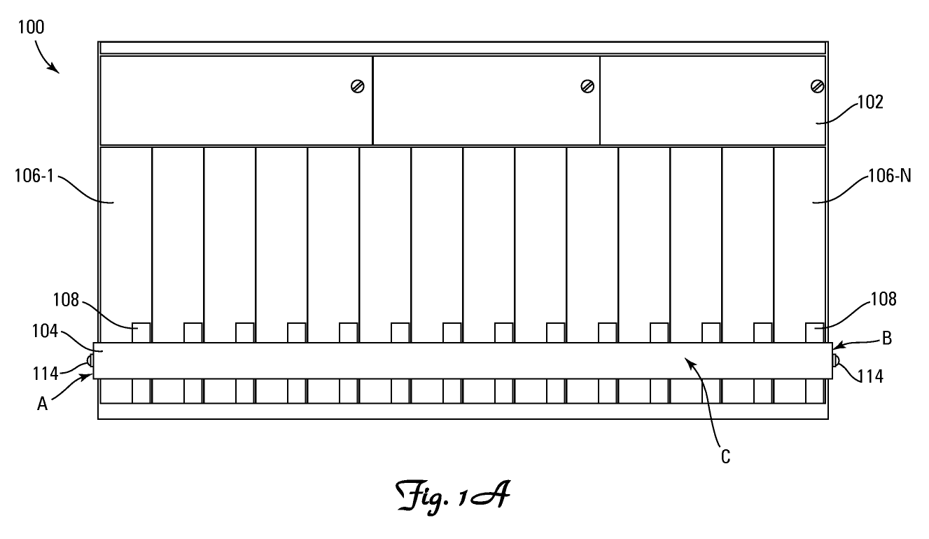

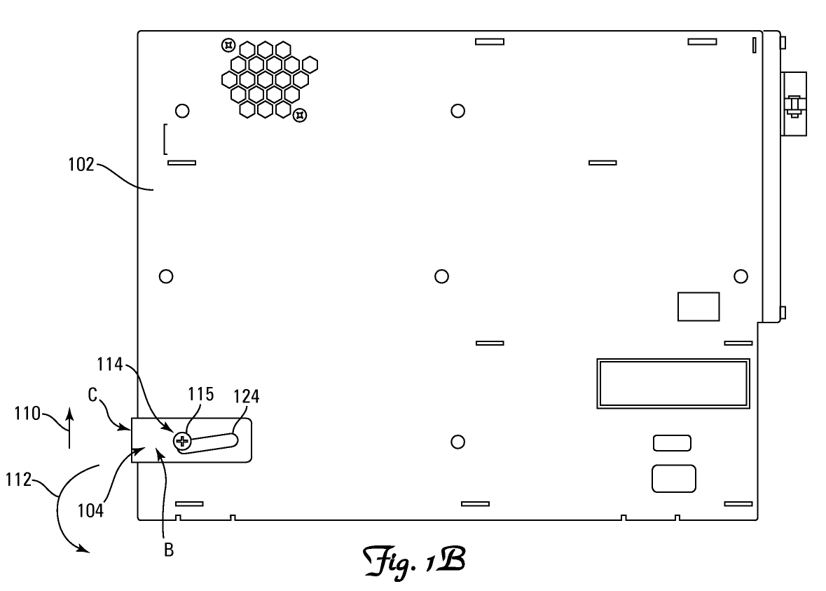

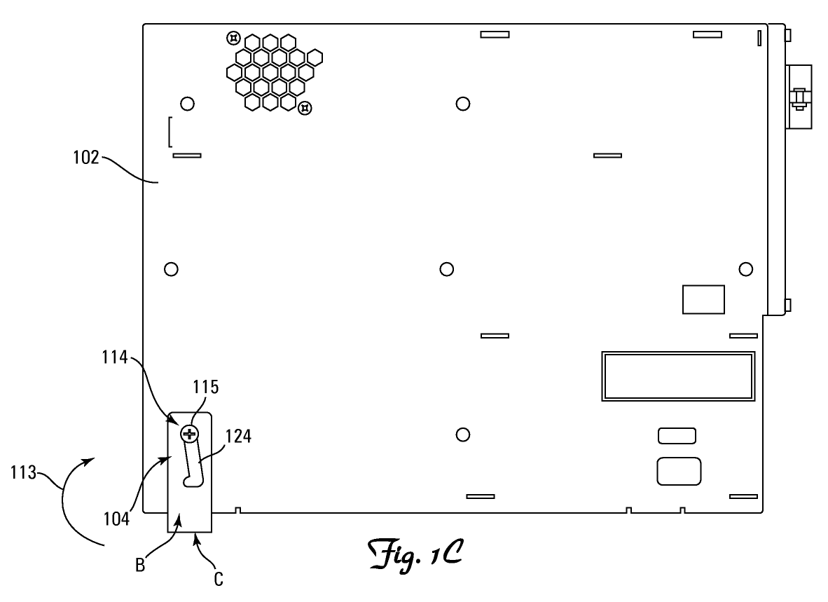

FIGS. 1A-1C depict a modular chassis system 100 according to one embodiment of the present invention. In particular FIG. 1A is a front view of modular chassis system 100 and FIGS. 1B and 1C are side views of modular chassis system 100. Modular chassis system 100 includes a chassis 102 and a lock bar 104. Chassis 102 is configured to receive one or more line cards 106-1 . . . 106-N. The total number of line cards 106-1 . . . 106-N which can fit into chassis 102 depends on the size and type of chassis 102. For example, in this embodiment, chassis 102 is a 3190 mechanics shelf. However, embodiments of the present invention are not to be so limited. In particular, in other embodiments, chassis 102 can be a 3192 mechanics shelf, a 220 mechanics shelf, etc. In addition to the type of chassis, some types have different sizes. For example, in this embodiment, chassis 102 is 17 inches wide. However, in other embodiments, other sizes can be used. For example, a 3192 mechanics shelf can be a 19 inch or 23 inch shelf, referring to the width of the chassis. Embodiments of the present invention are applicable to any appropriate type and size of modular chassis.

Line cards 106-1 . . . 106-N are held in place inside of chassis 102 with a latch 108. As described above, latch 108 can become loosened by being bumped, getting caught on articles of clothing, moving due to vibrations during transport, etc. In some instances, when latch 108 becomes loosened, its associating line card is pulled out of chassis 102 either partially or completely. When the line card is pulled out of chassis 102 it loses its connection to a motherboard (not shown) inside chassis 102 and is thus disconnected from the network.

However, lock bar 104 is used in embodiments of the present invention to reduce the likelihood of line cards 106-1 . . . 106-N being unintentionally pulled out of chassis 102 and thereby being disconnected from the network. In particular, lock bar 104 has two rest positions. One rest position is the locked position as shown in FIGS. 1A and 1B. The other rest position is the unlocked position shown in FIG. 1C. In the locked position, part C of lock bar 104 extends across the width of chassis 102 at a height such that it crosses latches 108 of line cards 106-1 . . . 106-N. In this position, lock bar 104 prevents latches 108 from being moved due to bumping, vibration, etc. By blocking latches 108, lock bar 104 prevents removal of line cards 106-1 . . . 106-N when in the locked position.

In the unlocked position, shown in FIG. 1C, part C of lock bar 104 rests underneath chassis 102. Therefore, line cards 106-1 . . . 106-N can be inserted or removed. In addition, in moving between the locked and unlocked position, lock bar 104 is not removed or detached from chassis 102. Since lock bar 104 does not need to be detached from chassis 102, use of lock bar 104 is easier and more probable. For example, if lock bar 104 had to be detached, it is more likely that it could be lost, or that an operator could forget to replace lock bar 104 in the locked position after finishing work with line cards 106-1 . . . 106-N.

In this embodiment, lock bar 104 is comprised of aluminum. However, it is to be understood that lock bar 104 can be made of any suitable material in other embodiments. For example, suitable materials include, but are not limited to, plastics, composite materials (such as fiber reinforced polymers, metal alloys, etc.), metals (such as iron, lead, etc.), and ceramic materials (such as boron carbide, alumina, ceramic metal composites (cermets), etc.).

In operation, one or more line cards 106-1 . . . 106-N are inserted into chassis 102 when lock bar 104 is in the unlocked position. Once line cards 106-1 . . . 106-N are inserted into chassis 102 and secured with latches 108, lock bar 104 is moved to the locked position to prevent accidental removal of one of line cards 106-1 . . . 106-N. When a line cards needs to be removed or inserted, lock bar 104 is lifted upward (towards the top of the page in FIG. 1B as indicated by arrow 110) to unlock lock bar 104. It is then pulled forward and rotated down to the unlocked position (as indicated by arrow 112 in FIG. 1B). Once the line card has been removed or inserted, lock bar 104 is rotated up and pushed in to the locked position again as indicated by arrow 113 in FIG. 1C.

Lock bar 104 rotates to the locked and unlocked positions via slot 124 in parts A and B of lock bar 104 and fastener 114. Fastener 114 is inserted into slot 124 and attached to a side of chassis 102. Fastener 114 is a screw in this embodiment. However, in other embodiments, other fasteners can be used, such as bolts, rivets, nails, pins, etc. The head 115 of fastener 114 is too large to fit through slot 124 thereby attaching lock bar 104 to chassis 102. Slot 124 then enables lock bar 104 to move about fastener 114 between the locked and unlocked positions as described in more detail below.

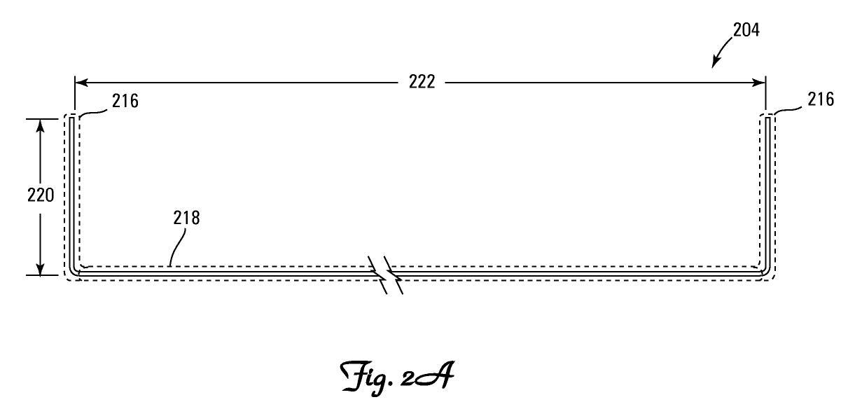

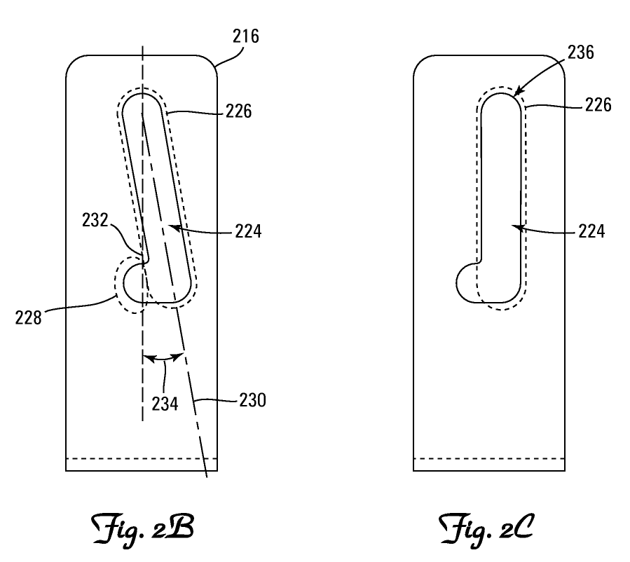

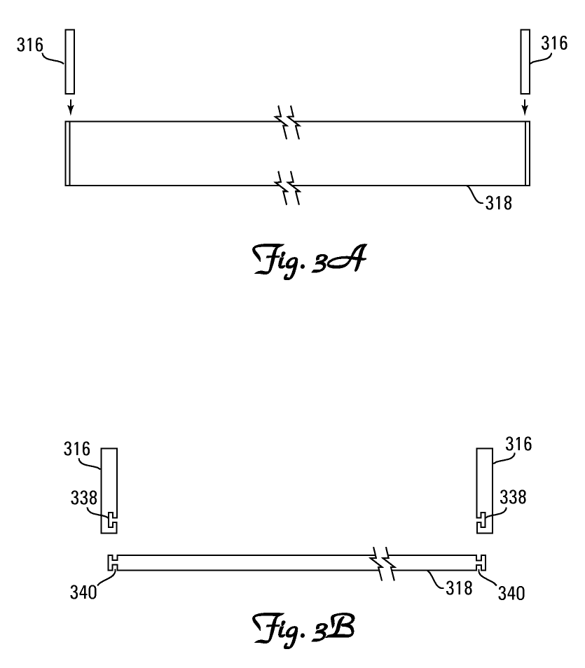

FIG. 2A depicts a top view of a lock bar 204 according to one embodiment of the present invention. Lock bar 204 can be used in conjunction with a modular chassis such as chassis 102 in modular chassis system 100 in FIG. 1 above. As shown in FIG. 2A, lock bar 204 is divided into three portions or sections. The three sections include two end sections 216 and a middle section 218. In this embodiment, the three sections form one continuous bar with end sections 216 being bent perpendicular to middle section 218. However, in other embodiments, end sections 216 and middle section 218 can be coupled together using other means, such as screws, brackets, sections welded together, etc. For example, in FIG. 3, discussed below, end sections 316 are coupled to middle section 318 using mating guide rails which lock together. Such embodiments, in which the sections are separable, are useful for easier storage and/or shipping of the lock bar.

As shown in FIG. 2A, end sections 216 have a length 220 and middle section 218 has a length 222. Length 222 is determined by the type and size of a chassis (such as chassis 102) to which lock bar 204 is to be attached. In particular, length 222 is slightly longer than the width of the chassis to which it is to be attached. In some embodiments, length 222 is approximately ⅛ inch longer than the width of the chassis. For example, in this embodiment, length 222 of middle section 218 is 17.125 inches for use with ADC's Kentrox PairGain Campus-RS Star Concentrator (CACNS700) chassis (also referred to as a Star Concentrator chassis) which is approximately 17.0 inches wide. Hence, length 222 in this embodiment is approximately ⅛ inch longer than the width of the chassis. However, it is to be understood that embodiments of the present invention are not to be so limited. In particular, length 222 can be implemented with other lengths for use with other chassis types and widths as described above.

Similarly, in this embodiment, length 220 of end sections 216 is 2.06 inches which enables enough length to allow lock bar 204 to clear a bottom edge of the chassis to which it is attached when rotated to and from the unlocked position (as shown in FIG. 1C above). However, it is to be understood that embodiments of the present invention are not limited to a length of 2.06 inches. In particular, any suitable length can be used, in other embodiments, which allows lock bar 204 to clear the bottom edge of the chassis when rotated to and from the unlocked position.

Lock bar 204 rotates to/from the locked and unlocked positions via slot 224 in each of end sections 216 (shown in FIGS. 2B and 2C) and a fastener (shown in FIG. 1) which attaches lock bar 204 to the chassis. Slot 224 has a long section 226 and an indent 228 forming an L-shape in this embodiment. When lock bar 204 is in the locked position, the fastener is located in indent 228 which prevents lock bar 204 from moving. When lock bar 204 is in the unlocked position, the fastener is in the long section 226 allowing lock bar 204 to move.

As shown in FIG. 2B, in some embodiments, slot 224 has an L-shape with major axis 230 of long section 226 offset from longitudinal axis 232 of end section 216 by an offset angle 234. As used herein, major axis 230 refers to the axis which passes through the center of long section 226 throughout the length of long section 226. Offset angle 234 measures the offset in degrees between major axis 230 and longitudinal axis 232 of end section 216. Offset angle 234 is measured in a counter-clockwise direction starting at longitudinal axis 232. In this embodiment, offset angle 234 is approximately 10 degrees. However, embodiments of the present invention are not to be so limited. Having offset angle 234 enables lock bar 204 to rotate downward at the same time as it is pulled away from the chassis in order to clear a bottom edge of the chassis.

In other embodiments, as shown in FIG. 2C, slot 224 has an offset angle of substantially 0 degrees. In this embodiment, lock bar 204 is first pulled out until the fastener is at the end 236 of long section 226. Lock bar 204 can be rotated to/from the unlocked position and clear the bottom edge of the chassis.

FIGS. 3A and 3B depict an exploded front view and top view, respectively, of a lock bar 304 according to another embodiment of the present invention. As discussed above, in some embodiments, end sections 316 and middle section 318 are separable pieces. In particular, in the embodiment shown in FIGS. 3A and 3B, end sections 316 are coupled to middle section 318 with mating guide rails 338 and 340. As shown in FIG. 3A, guide rail 338 of each end section 316 is slid onto guide rail 340 of middle section 318 which locks the two end sections 316 together with middle section 318 using techniques known to one of skill in the art. In this way, end sections 316 and middle section 318 require less space when stored and are less likely to be bent or otherwise damaged when shipped.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A lock bar comprising:
two end sections, each end section including a slot configured to enable attaching the lock bar to a modular chassis and to enable moving the lock bar between a locked position and an unlocked position when the lock bar is attached to the modular chassis; and
a middle section coupled to the two end sections and configured with a length longer than the width of the modular chassis.

2. The lock bar of claim 1, wherein the slot in each of the two end sections comprises an L-shaped slot.

3. The lock bar of claim 1, wherein a major axis of the slot in each of the end sections is offset in a counter-clockwise direction from a longitudinal axis of each end section by an offset angle.

4. The lock bar of claim 3, wherein the offset angle is approximately 10 degrees.

5. The lock bar of claim 1, wherein the middle and end sections are comprised of one of a plastic material, a composite material, a metal, and a ceramic material.

6. The lock bar of claim 1, wherein the middle and end sections form one continuous bar, the end sections being bent perpendicular to the middle section.

7. The lock bar of claim 1, wherein the middle and end sections are separable sections.

8. The lock bar of claim 1, wherein the length of the middle section is approximately ⅛ inch longer than the width of the modular chassis.

9. A modular chassis system comprising:
a modular chassis configured to receive one or more line cards;
two fasteners, each fastener including a head; and
a lock bar coupled to the modular chassis via the two fasteners, the lock bar comprising:
two end sections, each end section including a slot, the slot being smaller than the head of the two fasteners such that each end of the lock bar is attached to the modular chassis by inserting one of the two fasteners into the slot and attaching each fastener to a side of the modular chassis, wherein the slot is further configured to enable moving the lock bar between a locked position and an unlocked position; and
a middle section coupled to the two end sections and configured with a length longer than the width of the modular chassis.

10. The modular chassis system of claim 9, wherein the slot in each of the two end sections comprises an L-shaped slot.

11. The modular chassis system of claim 9, wherein a major axis of the slot in each of the two end sections is offset in a counter-clockwise direction from a longitudinal axis of each end section by an offset angle.

12. The modular chassis system of claim 11, wherein the offset angle is approximately 10 degrees.

13. The modular chassis system of claim 9, wherein the middle and end sections are comprised of one of a plastic material, a composite material, a metal, and a ceramic material.

14. The modular chassis system of claim 9, wherein the middle and end sections form one continuous bar, the end sections being bent perpendicular to the middle section.

15. The modular chassis system of claim 9, wherein the middle and end sections are separable sections.

16. The modular chassis system of claim 9, wherein the length of the middle section is approximately ⅛ inch longer than the width of the modular chassis.

17. The modular chassis system of claim 9, wherein the chassis is one of a 3190 mechanics shelf, a 3192 mechanics shelf, a 220 mechanics shelf, and a Star Concentrator chassis.

18. The modular chassis system of claim 9, further comprising one or more line cards inserted into the modular chassis.

19. The modular chassis system of claim 9, wherein each of the two fasteners comprises one of a screw, bolt, rivet, nail, and pin.

20. A modular chassis system comprising:
a modular chassis;
two fasteners, each fastener including a head; and
a lock bar coupled to the modular chassis via the two fasteners, wherein the lock bar is a continuous bar bent at each end to form two end sections and a middle section, each end section including an L-shaped slot configured to receive one of the two fasteners and enable moving the lock bar about the two fasteners between a locked position and an unlocked position, wherein the middle section of the lock bar prevents removal of line cards from the modular chassis when in the locked position and allows removal of line cards when in the unlocked position.

21. The modular chassis system of claim 20, wherein a major axis of the slot is offset from an axis of each of the two end sections by an offset angle.

22. The modular chassis system of claim 21, wherein the offset angle is approximately 10 degrees.

23. The modular chassis system of claim 20, wherein the lock bar is comprised of one of a plastic material, a composite material, a metal, and a ceramic material.

24. The modular chassis system of claim 20, wherein the chassis is one of a 3190 mechanics shelf, a 3192 mechanics shelf, a 220 mechanics shelf, and a Star Concentrator chassis.

25. A lock bar comprising:
two end sections, each of the two end sections including an L-shaped slot configured to enable attaching the lock bar to a modular chassis and to enable moving the lock bar between a locked position and an unlocked position when the lock bar is attached to the modular chassis, wherein a major axis of the L-shaped slot in each of the two end sections is offset in a counter clockwise direction from a longitudinal axis of each end section by an offset angle; and
a middle section, the middle section being longer than the width of the modular chassis such that each of the two end sections is attached to a side of the modular chassis;
wherein the two end sections and the middle section comprise one continuous bar, the end sections being bent perpendicular to the middle section.

26. The lock bar of claim 25, wherein the offset angle is approximately 10 degrees.

27. The lock bar of claim 25, wherein the lock bar is comprised of one of a plastic material, a composite material, a metal, and a ceramic material.
